(19) United States
(12) Patent Application Publication
(10) Pub. No.: US 2010/0316032 A1
(43) Pub. Date: Dec. 16, 2010

(54) Service Period Recovery wIth Source/Destination help

(75) Inventors: Liwen Chu, San Ramon, CA (US); George Vlantis, Sunnyvale, CA (US)

Correspondence Address: STMICROELECTRONICS, INC., MAIL STATION 2346, 1310 ELECTRONICS DRIVE, CARROLLTON, TX, 75006, US

(73) Assignee: STMicroelectronics, Inc., Carrollton, TX (US)

(21) Appl. No.: 12/813,080

(22) Filed: Jun. 10, 2010

Related U.S. Application Data
(60) Provisional application No. 61/185,873, filed on Jun. 10, 2009.

(51) Int. Cl. H04W 28/00

(52) U.S. Cl. 370/338

(57) ABSTRACT

SP recovery between communications of a source and destination apart from the PCP can occur by performing, prior to the initial frame response between a source and a destination, a back-off procedure using back-off parameters for SP recovery when the initiator of a SP cannot receive a responding frame from the destination and detects the communication medium being idle. In alternative embodiments the source and/or destination can send a notification frame to the PCP informing the PCP of transmission failure. When the PCP determines the communication medium to be idle, the PCP truncates and reallocates the remaining portion of the SP.

### RELATED APPLICATION

The present application relates to and claims the benefit of priority to U.S. Provisional Patent Application No. 61/185,873 filed Jun. 10, 2009 which is hereby incorporated by reference in its entirety for all purposes as if fully set forth herein.

### BACKGROUND OF THE INVENTION

1. Field of the Invention

Embodiments of the present invention relate, in general, to service periods in wireless networks and more particularly to service period recovery with source/destination assistance.

2. Relevant Background

Within wireless communication systems, a wireless communication device is normally referred to as a station STA (e.g., a wireless station). Examples of wireless stations (STAs) include a wide variety of wireless communication devices (e.g., computers including laptop computers, PDAs, cell phones, etc.). In addition, various wireless communication systems can be configured to operate using different means of communication (e.g., ad hoc, peer to peer, etc.). The basic building block of a wireless network is a Basic Service Set (BSS). A BSS is a group of STAs that communicate with each other. Communications take place within the area surrounding these stations called a Basic Service Area (BSA). The BSA is defined by the propagation characteristics of the wireless medium.

An Independent BSS (IBSS) is one in which stations can communicate directly with each other and thus must be within direct communication range. Typically, IBSS networks are composed of small numbers of stations set up for a specific purpose or for a short period of time. One common use is to create a short-lived network to support a single meeting in a conference room. Due to the short duration, small size, and focused purpose, IBSSs are sometimes referred to as ad hoc BSS or an ad hoc network. Such small personalized type of ad hoc networks are also referred to as personal or private IBSS networks (PBSS).

In some wireless communication systems, a PBSS coordinator point (PCP) may operate as a central governing communication device to which and through which various other STAs within the wireless communication systems communicate. For example, the PCP may serve as a coordinator of various other STAs within the wireless communication system or BSS, and it may also serve as a gateway to another network (e.g., a wide area network (WAN), the Internet, etc.). Stations communicate among each other via frames on a communication medium, normally a channel.

In addition to data frames that carry information from higher layers, 802.11 includes management and control frames that support data transfer. These are the frames on which the PCP operates. The beacon frame, which is a type of management frame, provides the “heartbeat” of a wireless LAN, enabling stations to establish and maintain communications in an orderly fashion.

A typical beacon frame is approximately fifty bytes long, with about half of that being a common frame header and cyclic redundancy checking (CRC) field. As with other frames, the header includes source and destination MAC addresses as well as other information regarding the communications process. The destination address is normally set to all ones, which is the broadcast Medium Access Control (MAC) address. This allows all other stations on the applicable channel to receive and process each beacon frame. The CRC field provides error detection capability.

The beacon's frame body resides between the header and the CRC field and constitutes the other half of the beacon frame. Each beacon frame carries one or more of the following information items in the frame body: beacon interval, timestamp, service set identifier, supported rates, parameter sets, capability information and traffic indication map.

The beacon interval represents the amount of time between beacon transmissions. Before a station enters power save mode, the station needs the beacon interval to know when to wake up to receive the beacon (and learn whether there are buffered frames at the access point). The beacon interval includes a data transfer time (DTT) which includes a contention-based period and a plurality of service periods. The service periods include an isochronous service period or pseudo-static service period and asynchronous service period or a service period request/allocation per beacon interval.

A contention-based protocol (CBP) or period is a communications protocol for operating wireless telecommunication equipment that allows many users to use the same radio channel without pre-coordination. The “listen before talk” operating procedure in IEEE 802.11 is the most well known contention-based protocol. Using a contention-based protocol, multiple independent stations can interact without central control. Before attempting to transmit, each station checks whether the medium is idle. If the medium is not idle, stations defer to each other and employ an orderly exponential back-off algorithm to avoid collisions.

Following a CBP in a beacon interval are typically a plurality of service periods (SPs).

“Isochronous” literally means to occur at the same time or at equal time intervals. In general English language, it refers to something that occurs at a regular interval of the same duration, as opposed to synchronous which refers to more than one thing happening at the same time. The term is used in different technical contexts, but often refers to the primary subject maintaining a certain interval, despite variations in other measurable factors in the same system.

In telecommunication, isochronous is known to mean a periodic signal pertaining to transmission in which the time interval separating any two corresponding transmissions is equal to the unit interval or to a multiple of the unit interval.

When a transfer of information is “synchronous,” the sending and receiving devices are synchronized, such as by using the same clock signal, and the transfer of information re-occurs at identical periodic intervals. For example, the IO device 10 can send a synchronous message, indicating the camera's current mode, to the computer system 100 once every second. However, because the IO device 10 and the computer system 100, or components within the computer system 100, may be difficult to synchronize, a synchronous transfer of information may not be appropriate in some situations.

When a transfer of information is “isochronous,” the sending and receiving devices are only partly synchronized, but the sending device transfers information to the receiving device at regular intervals. Such transfers can be used, for example, when information needs to arrive at the receiving device at the same rate it is sent from the sending device, but without precise synchronization of each individual data item. For example, an Input/Output device may send an isochronous stream of video information to the computer system which ensures that the information flows continuously, and at a steady rate, in close timing with the ability of the computer system to receive and display the video. While a synchronous transfer of information typically involves having each data transfer occur at the same time with respect to a clock signal, an isochronous transfer of information may require that up to “X” bits of data be transferred every “T” time units, although precisely when the X bits are transferred within the time T can vary.

In telecommunications, asynchronous communication is transmission of data without the use of an external clock signal. Any timing required to recover data from the communication symbols is encoded within the symbols. The most significant aspect of asynchronous communications is variable bit rate, or that the transmitter and receiver clock generators do not have to be exactly synchronized.

Each of the aforementioned techniques for access to the communication medium has advantages and disadvantages. The beacon frame can be used to announce an isochronous and/or asynchronous service period. When there is unused time a three stage method is used to dynamically allocate a service period. FIG. 1 graphically depicts a SP allocation as would be known to one of ordinary skill in the art.

The process begins with a polling period 110 in which the PCP polls each station with respect to its needs for data transfer. From that polling one or more stations issue a channel time request (CTRq) 120. Having received one or more requests for allocation of the service period the PCP makes a period grant 130 that conveys an allocation to one or more stations. Having been granted an allocation 135 data transfer occurs 140.

During such an allocation of time the station can communicate data to the PCP. The PCP thus assumes that during a service period the station points its antenna at the PCP so as to send data to the PCP during the service period. If the PCP, after allocation, does not receive any data, i.e. the channel is idle, the PCP may truncate the service period and reallocate the remaining portions to another station. The station to which the SP is allocated may also communicate with other non-PCP stations and they, too, may not use the entire SP. Unfortunately, these non-PCP stations cannot recover the unused SP time. Thus only when the PCP is either the source or the destination is unused service period time recovered.

This challenge of the prior art is compounded when the destination fails to receive frames from the source or when it cannot reply to the source. The failure to receive information or respond is, in one instance, the result of collisions. Collisions can occur when the SP and CBP in the same PBSS interfere with one another. Collisions can also occur when SPs and CBPs in overlapping PBSSs interfere with each other and when SPs in the same PBSS interfere with each other. Finally SPs in overlapping PBSSs can interfere with each other.

Another reason for data transfer failure during a SP is that the source and destination have not directed their antenna toward each other. A source may receive the SP information while the destination fails to do so when the destination's antenna remains pointed toward the PCP and not the source during the allocated SP. In both of these scenarios used SP time is lost.

It continues, therefore, to be a challenge to recover unused allocated service period time when both the source and destination of a communication does not involve a PCP. A need exists therefore for a method or protocol and associated system to recover unused service period time when both the source and destination of a SP are not a PCP. These and other challenges of the prior art are addressed by one or more embodiments of the present invention.

### SUMMARY OF THE INVENTION

SP recovery can occur by performing, prior to the initial frame response between a source and a destination, a back-off procedure using back-off parameters for SP recovery when the initiator of a SP cannot receive a responding frame from the destination and detects the communication medium being idle. In this instance the SP back-off parameter gives higher priority to the SP than the CBP. Thus the collision between SP and CBP is resolved.

According to another embodiment of the present invention, after a valid response to an initial frame of a SP from the source has been received from the destination, the initiator of the SP (source) can send the previously sent data frame again when the initiator of the SP cannot receive or did not receive additional response frames from the destination and detects that the communication medium is idle. The SP is given a higher priority than the CBP resolving collisions between the SP and CBP.

According to another embodiment of the present invention, when the source cannot receive a reply from the destination after transmitting the first frame to the destination in a SP, the source can send a notification frame to the PCP informing the PCP of the transmission failure. This notification frame can be a new defined frame. When the PCP receives a notification frame and independently detects the channel (communication medium) being idle for a certain period of time (except for the communication from the source), the PCP can truncate and reallocate the remaining part of the service period.

When a SP's destination receives SP information from the PCP but the source does not receive the same SP information from the PCP, the SP's destination will not receive data frames from the SP's source. According to one embodiment of the present invention, when the expected transmission does not occur from the source and the destination detects the channel being idle for a predetermined period of time, the destination can send a notification frame to the PCP. When the PCP receives a notification frame from the destination of an idle communication medium and independently detects the channel being idle for a predetermined period of time, the PCP can truncate and reallocate the remaining portion of the SP.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 depicts an example of SP allocation as would be known to one of ordinary skill in the art;

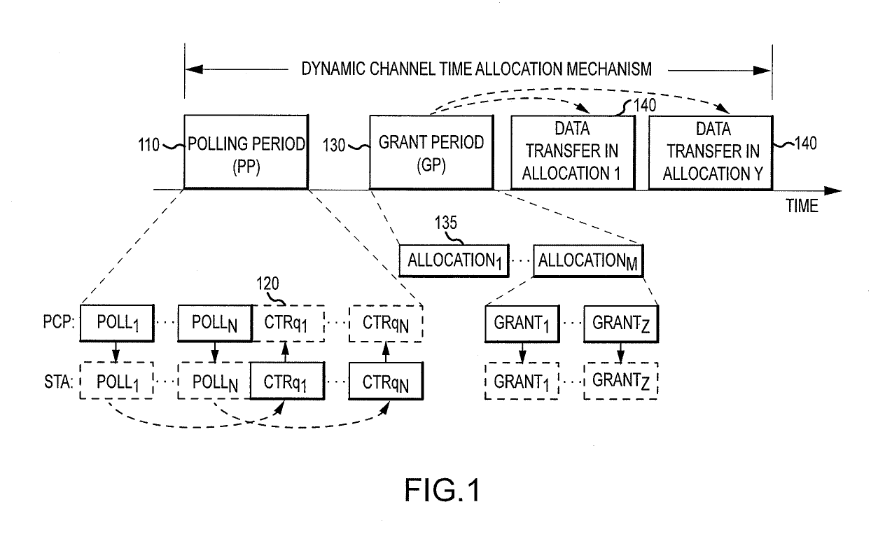

FIG. 2 shows two overlapping independent BSS networks creating a clustered wireless environment in which SP recovery between a source and a destination is resolved by one or more embodiments of the present invention;

FIG. 3 is a flowchart of one method embodiment of the present invention for SP recovery using source help;

FIG. 4 is a flowchart of another method embodiment of the present invention for SP recovery using source help;

FIG. 5 is a flowchart of another method embodiment of the present invention for SP recovery using source help; and

FIG. 6 is a flowchart of one method embodiment of the present invention for SP recovery using destination help.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be, understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Included in the description are flowcharts depicting examples of the methodology which may be used for SP recovery. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

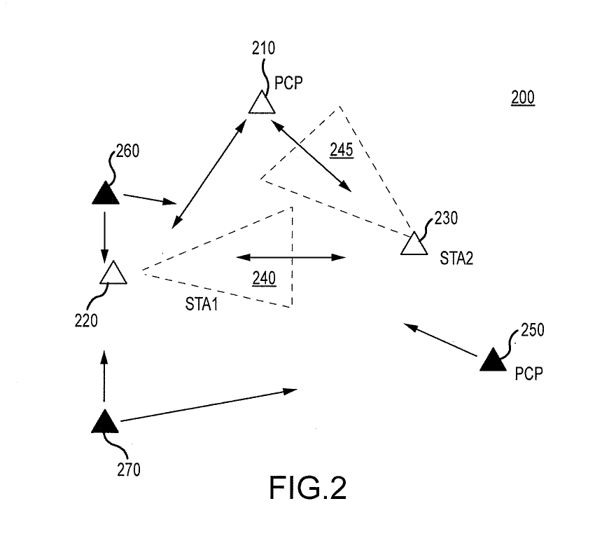

FIG. 2 shows an overlapping PBSS network environment according to one embodiment of the present invention. As can be seen in FIG. 2, two PBSS networks overlap forming what is commonly referred to in the art as a wireless network 200. Each of the PBSS networks includes a PCP 210, 250 that respectively controls the communication between the stations 230, 240, 260, 270, within their respective networks. Within each respective network, communication takes place between the PCP 210, 250 and stations 230, 240, 260, 270 as well as between the stations themselves. As both PBSS networks utilize the same communication medium, collisions can occur if the communications between stations, or between the PCP and stations, take place at the same time. Also illustrated with respect to one PBSS network is a representative antenna reception pattern 240, 245 associated with two stations 220, 230 respectively.

During a service period collisions can occur when communications in various PBSS networks exist either between the PCP and stations or between the stations themselves. While SP allocation between the PCPs themselves tries to alleviate such collisions, the common occurrence of communication directly between stations within the PBSS network can create an inefficient utilization of unused SP time.

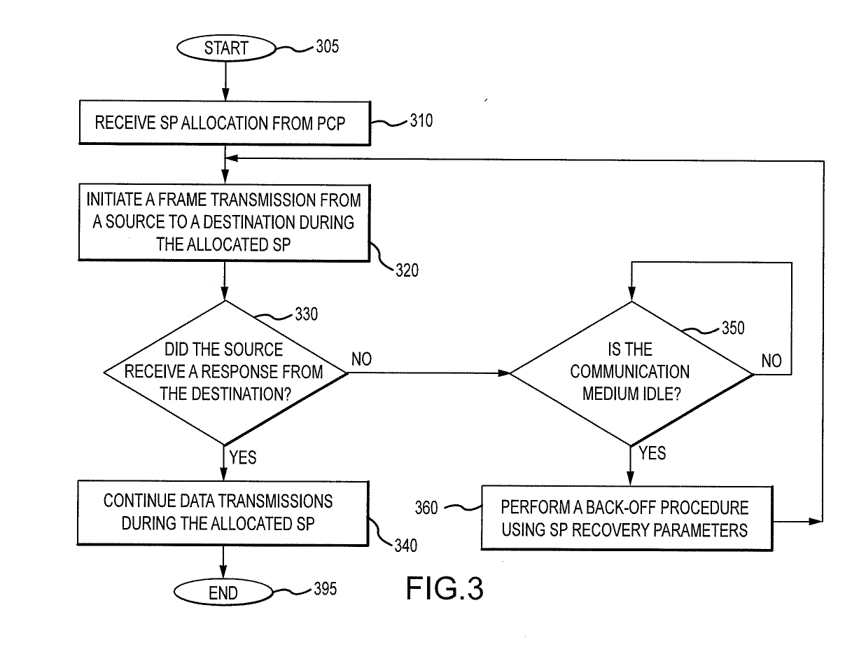

FIG. 3 is a flowchart of one method embodiment of the present invention to recover unused SP time utilizing source help. The process begins 305 when the resource receives a SP allocation from a PCP 310. Upon receiving the SP allocation, the source initiates a frame transmission to a destination during allocated SP 320. (An optional back-off may be done before the first frame transmission during allocated SP). If the antenna of the destination and source are aligned or if the two stations are within sufficient range for omnidirectional reception, the destination will receive an initial frame transmission from the source and respond. However, it is possible that either the antenna of the destination and/or source is misaligned or that a collision occurs disrupting communication between source and destination.

A query therefore occurs, whether the source, having transmitted an initial message, received from the destination a response 330. If a response from the destination is received, then transmissions between the source and the destination continue 340 during the allocated SP 320. When the allocated SP terminates, communications cease and the process ends 395.

If, however the source fails to receive a response from the destination 330, the source examines the communication medium to determine when the communication medium is idle 350.

When the source fails to detect data transfer on the communication medium for a predetermined period of time (communication medium idle for SP Receiver Inter Frame Space (SPRCVRIFS)), the source initiates a back-off procedure 360 using the back-off parameters for SP recovery.

Recall that one possibility for the lack of acknowledgement from the destination to the source is a collision between SP and CBP procedures. A back-off using back-off parameters for SP recovery provides a higher priority to SP than CBP. Such a change in priority between SP and CBP alleviates collisions between SP and CBP protocols. Thus this method not only can resolve a collision between SP and CBP but also between SPs themselves.

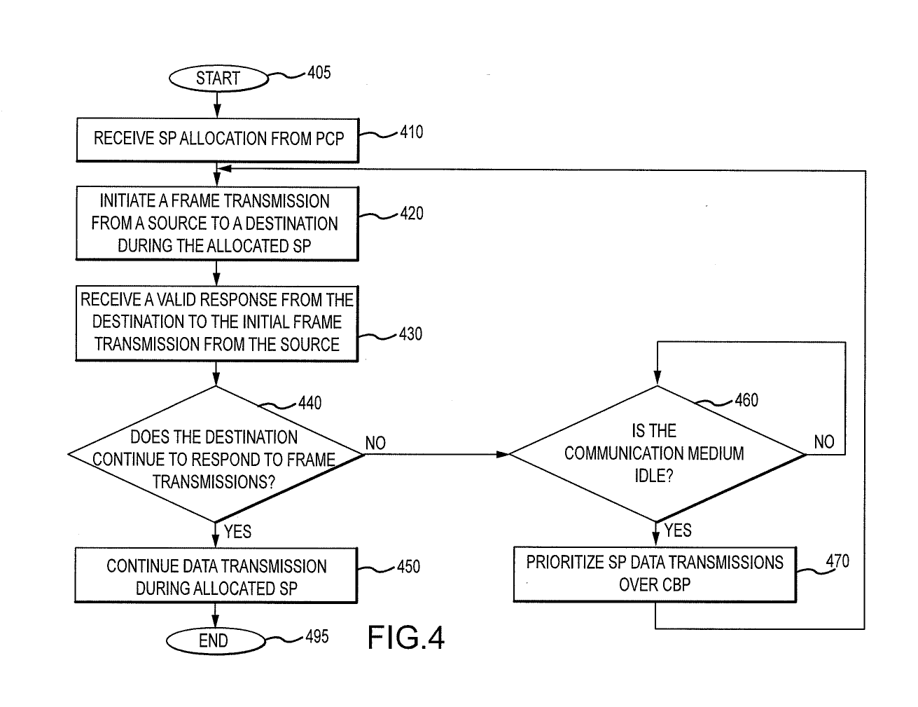

FIG. 4 is a flowchart, according to one embodiment of the present invention, depicting a method for SP recovery using source help. As with the previous example shown in FIG. 3, the method depicted in FIG. 4 utilizes help from the source to recover unutilized SP time. Again the process starts 405 with the source receiving a SP allocation from PCP 410. With the SP allocation in hand, the source initiates a frame transmission from the source to destination during the allocated SP 420. Again, an optional back-off may be done before the first frame transmission during the allocated SP.

Unlike the previous example, the destination's response to the initial frame transmission from the source establishes a link between the source and the destination 430. However, during the transmission of data between the source and the destination, a problem may arise disrupting communication and ceasing transmissions. Upon recognizing the disruption of communication, a query is made whether the destination continues in response to frame transmissions 440. If the destination responds to data transmissions during allocated SP, data transmission continues 450 until the SP terminates and data transmission ceases, ending the process 495.

When, however, the destination fails to respond, transmissions from the source 440 the source determines whether the communication medium is idle 460. When the communication medium is not idle, meaning that some transmissions during the SP are occurring, the source reinitiates a frame transmission from the source to the destination to reestablish contact and communications between the destination and source 420 after the medium is idle and a back-off has elapsed.

When the communication medium remains idle for a predetermined period of time (SPRCVRIFS) 460, the SP gives a higher priority to SP operations than CBP operations. Such a change priority between SP and CBP alleviates collisions between SP and CBP protocols. However a higher priority to SP does not prevent collisions between common SPs.

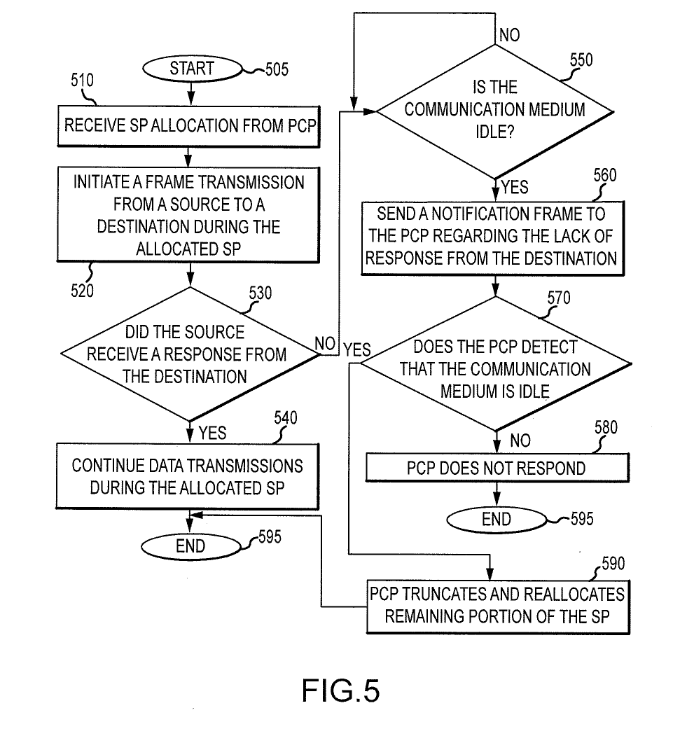

Another method of SP recovery using source help is depicted in the flowchart shown, according to one embodiment of the present invention, in FIG. 5. Again the process starts 505 with the receipt of the SP allocation from PCP 510. The source initiates a frame transmission to the destination during the allocated SP 520 with an optional back-off done before the first frame transmission during allocated SP. If the destination responds to the source's initial frame transmission 530, data transmissions continue during allocated SP 540. Upon termination of the SP, transmissions cease and the process ends 595.

If, however, the source fails to receive a response from the destination 530, the source observes the communication medium to determine whether the communication medium is idle for a predetermined period of time 550. If the communication medium is active, the source waits until the medium is idle. The source may do a back-off procedure and send a frame again to the destination before sending notification frame to the PCP when the communication medium is idle.

When a communication medium remains idle for a predetermined period of time (SPRCVRIFS or SP idle time), the SP sends a notification frame to the PCP regarding the lack of response from the destination 560. This notification frame may be a new defined frame.

Upon receiving notification from the source of the idle communication medium, the PCP examines the communication medium to determine whether it is idle 570. If the PCP determines that the communication medium is not idle, the PCP does not respond.

When the PCP concurs with a determination that the communication medium is idle 570, the PCP truncates and reallocates remaining portions of the SP 590. With the unused portion of the SP recovered, the process ends 595.

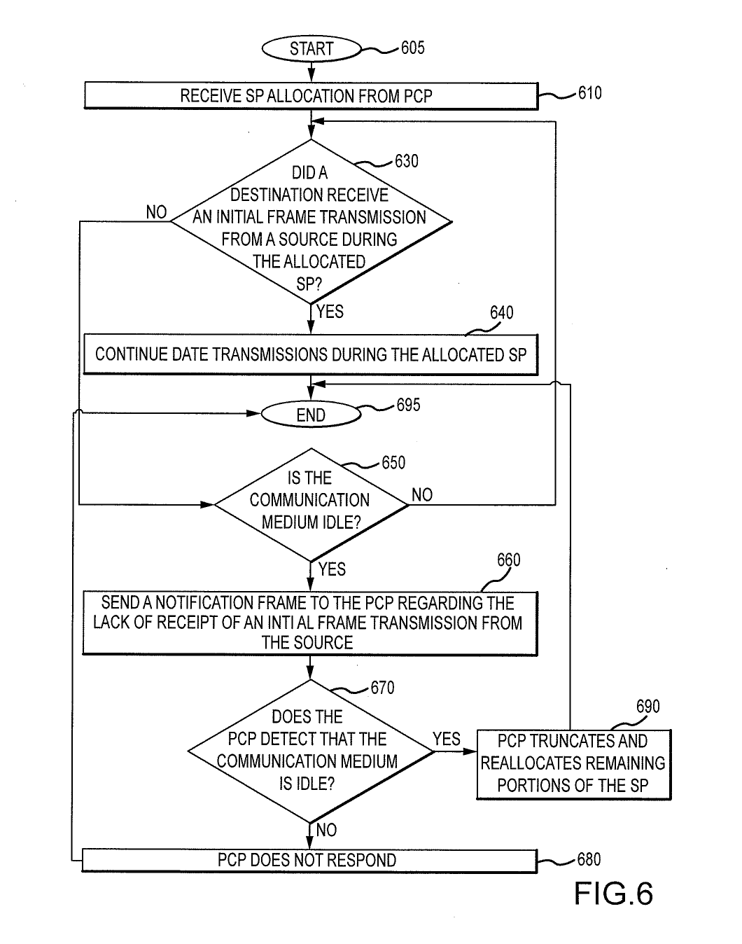

FIGS. 3, 4 and 5 each show a unique methodology for recovering unused portions of SP allocations between the source and the destination if the communication link between the source and the destination fails. As will be subsequently shown in FIG. 6, unused portions of SP allocation can also be recovered with the help of the destination.

FIG. 6 shows one method according to the present invention for recovering unused SP allocation between destination and source using destination help. The process begins 605 with a reception by a destination of SP allocation from PCP 610. As a destination is passive during the initial establishment of communications between source and destination, the initial inquiry occurs by whether the destination receives an initial frame transmission from a source during allocated SP 630.

If the destination receives an initial frame transmission from a source and a link is established between the source and destination, data transmission continues during allocated SP 640. Upon expiration of the allocated SP, transmissions cease ending the process 695.

If the expected transmission from the source does not arrive at the destination 630, the destination examines the communication medium to determine if it is idle 650. If the communication medium is determined to be active, the destination remains passive awaiting receipt of a message from the source 630.

When the destination determines, however, that the communication medium is idle for a predetermined period of time (SP idle time out) 650, the destination sends a notification frame to the PCP informing the PCP of the lack of receipt of initial frame transmission from the source 660. The PCP, upon receipt of a message from the destination indicating an idle communication medium, independently examines the communication medium to determine whether it is idle 670. If the communication medium is active the PCP does nothing 680 and the process ends 695.

When the PCP independent examination of the communication medium determines the communication medium is idle 670, the PCP truncates and reallocates the remaining portion of the SP thereby recovering unused SP time 690. With the recovery of unutilized SP time the process ends 695.

Embodiments of the present invention described above demonstrate how unutilized SP time between a communication source and destination apart from the PCP in a PBSS can be recovered with the assistance of either the source or the destination. By either initiating new protocols to establish new priorities so as to eliminate or reduce collisions, or to inform the PCP of an idle communication medium so that the SP can be truncated, unutilized SP time can be recovered.

The communication apparatus, and methods employed implemented on those apparatus, described in the present invention is illustrative of various wireless devices including, for example, mobile and cellular phone handsets, machine-to-machine (M2M) communication networks (e.g., wireless communications for vending machines), so-called “911 phones” (a mobile handset configured for calling the 911 emergency response service), as well as devices employed in emerging applications such as 3G, 4G, satellite communications, and the like. As such, wireless communication apparatus may provide RF reception functionality, RF transmission functionality, or both (i.e., RF transceiver functionality).

The communication apparatus of the present invention may be configured to implement one or more specific communication protocols or standards including those described in 802.11, as desired. For example, in various embodiments communication apparatus may employ a time-division multiple access (TDMA) standard or a code division multiple access (CDMA) standard to implement a standard such as the Global System for Mobile Communications (GSM) standard, the Personal Communications Service (PCS) standard, and the Digital Cellular System (DCS) standard. In addition, many data transfer standards that work cooperatively with the GSM technology platform may also be supported. For example, communication apparatus may also implement the General Packet Radio Service (GPRS) standard, the Enhanced Data for GSM Evolution (EDGE) standard, which may include Enhanced General Packet Radio Service standard (E-GPRS) and Enhanced Circuit Switched Data (ECSD), and the high speed circuit switched data (HSCSD) standard, among others.

Embodiments of the present invention have been herein described with reference to various wireless networks and their associated communication devices. Networks can also include mainframe computers or servers, such as a gateway computer or application server (which may access a data repository). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device such as data repository.

Those skilled in the art will appreciate that the gateway computer may be located a great geographic distance from the network, and similarly, the devices may be located a substantial distance from the networks. For example, the network may be located in California, while the gateway may be located in Texas, and one or more of the devices may be located in New York. The devices may connect to the wireless network using a networking protocol such as the Transmission Control Protocol/Internet Protocol (“TCP/IP”) over a number of alternative connection media, such as cellular phone, radio frequency networks, satellite networks, etc. The wireless network preferably connects to the gateway using a network connection such as TCP or UDP (User Datagram Protocol) over IP, X.25, Frame Relay, ISDN (Integrated Services Digital Network), PSTN (Public Switched Telephone Network), etc. The devices may alternatively connect directly to the gateway using dial connections. Further, the wireless network and network may connect to one or more other networks (not shown), in an analogous manner.

In some preferred embodiments, the present invention can be implemented in software while in others it can be implemented in firmware, hardware or a combination thereof. Software programming code which embodies the present invention is typically accessed by the microprocessor (e.g. of device and/or server) from long-term storage media of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory, and accessed by the microprocessor using the bus. The techniques and methods for embodying software programming code in memory, on physical media, and/or distributing software code via networks are well known and will not be further discussed herein.

A user may connect his/her computer to a server using a wireline connection or a wireless connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing capabilities (and communication capabilities, when the device is network-connected). The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with source and destination assisted SP recovery, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A method for source/destination assisted service period (SP) recovery, comprising:
receiving at a source, an allocation for a SP over a communication medium for data transfer between the source and a destination;
initiating at the source an initial frame transmission between the source and the destination during the SP;
responsive to failing to receive an initial frame transmission response from the destination, determining whether the communication medium is idle; and
responsive to the communication medium being idle for a predetermined period of time, performing a SP recovery parameter back-off procedure.

2. The method for source/destination assisted SP recovery of claim 1 wherein the predetermined period of time is determined by a point coordinator inter frame space (PIFS).

3. The method for source/destination assisted SP recovery of claim 1 wherein the predetermined period of time is determined by a SP receiver inter frame space (SPRCVRIFS).

4. The method for source/destination assisted SP recovery of claim 1 wherein the SP recovery parameter back-off procedure gives the SP a higher priority as compared to a contention based period (CBP).

5. The method for source/destination assisted SP recovery of claim 4 wherein the SP recovery parameter back-off procedure resolves SP/CBP collisions.

6. The method for source/destination assisted SP recovery of claim 5 wherein the SP recovery parameter back-off procedure resolves SP/SP collisions.

7. The method for source/destination assisted SP recovery of claim 1 further comprising responsive to receiving the initial frame transmission response from the destination, sending additional data frames to the destination and responsive to failing to receive an associated additional data frame response from the destination and detecting the communication medium is idle for a predetermined period of time, giving the SP a higher priority than a contention based period (CBP).

8. The method for source/destination assisted SP recovery of claim 7 wherein giving the SP a higher priority than the CBP resolves SP/CBP collisions.

9. The method for source/destination assisted SP recovery of claim 7 wherein the predetermined period of time is determined by a point coordinator inter frame space (PIFS).

10. The method for source/destination assisted SP recovery of claim 7 wherein the predetermined period of time is determined by a SP receiver inter frame space (SPRCVRIFS).

11. A method for source/destination assisted service period (SP) recovery, comprising:
receiving at a source from a personal independent basic service set (PBSS) control point (PCP), an allocation for a SP over a communication medium for data transfer between the source and a destination;
initiating at the source an initial frame transmission between the source and the destination during the SP;
responsive to failing to receive an initial frame transmission response from the destination, determining whether the communication medium is idle; and
responsive to the communication medium being idle for a predetermined period of time, sending a notification frame to the PCP informing the PCP that the communication medium is idle.

12. The method for source/destination assisted SP recovery of claim 11 wherein the predetermined period of time is a SP idle timeout period.

13. The method for source/destination assisted SP recovery of claim 11 wherein the notification frame is a new defined frame.

14. The method for source/destination assisted SP recovery of claim 11 further comprising determining by the PCP whether the communication medium is idle.

15. The method for source/destination assisted SP recovery of claim 14 responsive to the PCP determining that the communication medium is idle, truncating the SP and reallocating any remaining portions of the SP.

16. A method for source/destination assisted service period (SP) recovery, comprising:
receiving at a destination from a personal independent basic service set (PBSS) control point (PCP), an allocation for a SP over a communication medium for data transfer between a source and the destination;
receiving at the destination, an initial frame transmission from the source during the SP;
responsive to failing to receive an initial frame transmission from the source, determining whether the communication medium is idle; and
responsive to the communication medium being idle for a predetermined period of time, sending a notification frame to the PCP informing the PCP that the communication medium is idle.

17. The method for source/destination assisted SP recovery of claim 16 wherein the predetermined period of time is a SP idle timeout period.

18. The method for source/destination assisted SP recovery of claim 16 wherein the notification frame is a new defined frame.

19. The method for source/destination assisted SP recovery of claim 16 further comprising determining by the PCP whether the communication medium is idle.

20. The method for source/destination assisted SP recovery of claim 19 responsive to the PCP determining that the communication medium is idle, truncating the SP and reallocating any remaining portions of the SP.

21. A system for source/destination assisted service period recovery in personal independent basic service set wireless networks, comprising:
a personal independent basic service set (PBSS) network wherein said PBSS network includes a PBSS control point (PCP) and two or more stations (STAs);
a source station within the PBSS network;
a destination station within the PBSS network wherein each of the source station, destination station and the PCP within the PBSS network includes a machine capable of executing instructions embodied as software; and
a plurality of software portions, wherein
one of said software portions is configured to allocate to the source station and the destination station a SP for data transfer between the source station and the destination station over the communication medium,
one of said software portions is configured to initiate at the source station an initial frame transmission between the source station and the destination station, and
one of said software portions is configured to, responsive to failing to establish a communication link between the source station and the destination station, reallocate unused portions of the SP.

22. The system for source/destination assisted SP recovery of claim 21 wherein the plurality of software portions further includes one software portion configured to determine whether the communication medium is idle.

23. The system for source/destination assisted SP recovery of claim 22 wherein the plurality of software portions further includes one software portion configured to notify the PCP that the communication medium is idle.

24. The system for source/destination assisted SP recovery of claim 23 wherein the destination station notifies the PCP that the communication medium is idle.

25. The system for source/destination assisted SP recovery of claim 23 wherein the source station notifies the PCP that the communication medium is idle.

26. The system for source/destination assisted SP recovery of claim 21 wherein said software portion configured to reallocate unused portions of the SP truncates the SP responsive to the communication medium being idle.
